(19) United States
(12) Patent Application Publication
(10) Pub. No.: US 2010/0161506 A1
(43) Pub. Date: Jun. 24, 2010

(54) MOBILE DEVICE AND METHOD FOR PROVIDING LOGGING AND REPORTING OF USER-DEVICE INTERACTION

(75) Inventors: Tim Bosenick, Hamburg (DE); Thomas Knauer, Hannover (DE); Gavin Lew, Oakbrook Terrace, IL (US); Sven Körber, Hamburg (DE); Nikolaus Pohle, Hannover (DE)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: nurago GmbH, Hannover (DE)

(21) Appl. No.: 12/641,850

(22) Filed: Dec. 18, 2009

Related U.S. Application Data
(60) Provisional application No. 61/139,366, filed on Dec. 19, 2008.

(51) Int. Cl. G06Q 10/00; G06Q 50/00; H04W 4/12

(52) U.S. Cl. 705/347; 455/466

(57) ABSTRACT

An apparatus and method of conducting a study involving user interaction with mobile devices includes installing an application program executable by a processor for performing steps of the method on a mobile device, collecting and logging data pertaining to the mobile device, querying the user in response to a trigger event of the mobile device to which the logged data pertains, and collecting and logging feedback from the user, via user interaction with the mobile device, in response to the query.

### CROSS-REFERENCE TO RELATED PATENT APPLICATION

This application claims the priority benefit of U.S. Provisional Patent Application Ser. No. 61/139,366 entitled “Mobile Device Providing Logging and Reporting of User-Device Interaction” and filed on Dec. 19, 2008, which is hereby incorporated herein by reference.

### BACKGROUND

1. Field of the Invention

This invention pertains to mobile devices such as cell phones and methods for logging and reporting of user-device interaction.

2. Related Art

Usability testing of products such as software programs, web sites, or mobile devices with actual users is a critical component of a user-centric product design process. Likewise, market research and audience measurement are critical components for strategic product and service planning Conventional methods for usability testing typically rely on subjective feedback from users in response to a survey some time after the user has actually used the product being tested, or feedback obtained during testing in a controlled laboratory environment. Likewise, conventional methods for market research and audience measurement typically rely on surveys. Each of these conventional methods have problems leading to inaccurate assessments.

Usability testing in a controlled laboratory environment can be used to assess usability in a highly tactical and specific manner to provide insight into specific design issues. This tends to be a task-oriented usability assessment, and does not accurately reflect how the product would be used on a regular basis by those who own and use the product in their daily lives. Laboratory testing also typically focuses on a one-time user experience, and does not effectively capture user experience over an extended period of time.

Surveys or focus groups can be used to assess user or customer perceptions after using a product or service, as well as based on hearsay or desires. Surveys can also be used to statistically measure an audience for media such as radio and television stations or programs. However, feedback obtained in this manner is often largely retrospective and not as credible as if the user were providing the feedback during or immediately following using the product, service, feature, or enjoying the media program which is the subject of the feedback. A user's feedback decreases in accuracy after the passage of time due to the user's incomplete or selective memory and skewing of opinions based on various factors in the interim between using the product and providing the feedback.

### SUMMARY

Embodiments of the present invention include an apparatus and method for logging and reporting of user-device interaction, such as user interactions with mobile devices. These embodiments overcome problems of the prior art by facilitating real-time solicitation and collection of usage data and related user feedback involving interactions with a device, including feedback on software and functionality accessed through interaction with the device. Feedback on products, services, and media sources and programs which are not related to the device may also be provided by the user through interaction with the device. The device may include a mobile device such as a cellular telephone, smartphone, personal digital assistant (PDA), or network computer (e.g., nettop or netbook). An application program for collecting the data associated with the mobile device and related user feedback may be delivered to the mobile device (e.g., over a wireless network), be installed on the mobile device, collect the data and related user feedback, and then transmit the collected data and feedback to a central server over the wireless network for later analysis and reporting.

An exemplary method of conducting a study involving user interactions with mobile devices includes installing a program executable by a processor for performing steps of the method on a mobile device, collecting and logging data pertaining to the mobile device, querying the user in response to a trigger event of the mobile device to which the logged data pertains, and collecting and logging feedback from the user, via user interaction with the mobile device, in response to the query.

Another exemplary method of conducting a study involving user interactions with mobile devices includes transmitting to a mobile device a program executable by a processor for performing steps of the method for installation on the mobile device, retrieving logged data pertaining to the mobile device, and retrieving logged feedback collected from the user in response to a query triggered by an event of the mobile device to which the logged data pertains, the feedback collected via user interaction with the mobile device.

An exemplary mobile device for conducting a study involving user interactions with mobile devices includes a processor that executes instructions of a software program, a communications interface, communicatively coupled with the processor, that communicates with a central server over a network, and a memory communicatively coupled with the processor and having stored thereon a program executable by the processor for performing a method of conducting a study involving user interactions with mobile devices. The method performed by the exemplary mobile device includes collecting and logging data pertaining to the mobile device, querying the user in response to a trigger event of the mobile device to which the logged data pertains, and collecting and logging feedback from the user, via user interaction with the mobile device, in response to the query.

An exemplary computer-readable storage medium has stored thereon a program executable by a processor for performing a method of conducting a study involving user interactions with mobile devices. The method includes transmitting to a mobile device a program executable by a processor for performing steps of the method for installation on the mobile device, retrieving logged data pertaining to the mobile device, and retrieving logged feedback collected from the user in response to a query triggered by an event of the mobile device to which the logged data pertains, the feedback collected via user interaction with the mobile device.

### BRIEF DESCRIPTION OF THE DRAWINGS

FIG. 1 illustrates an exemplary user-device interaction logging and reporting system.

FIG. 2 illustrates an exemplary mobile device.

FIG. 3 illustrates an exemplary method of logging and reporting of user-device interaction.

FIG. 4 illustrates an exemplary method of conducting a study involving user-device interaction using logged data from a mobile device.

FIG. 5 illustrates an exemplary query displayed on a cell phone screen to sample the user's experience at a particular point in time.

### DETAILED DESCRIPTION

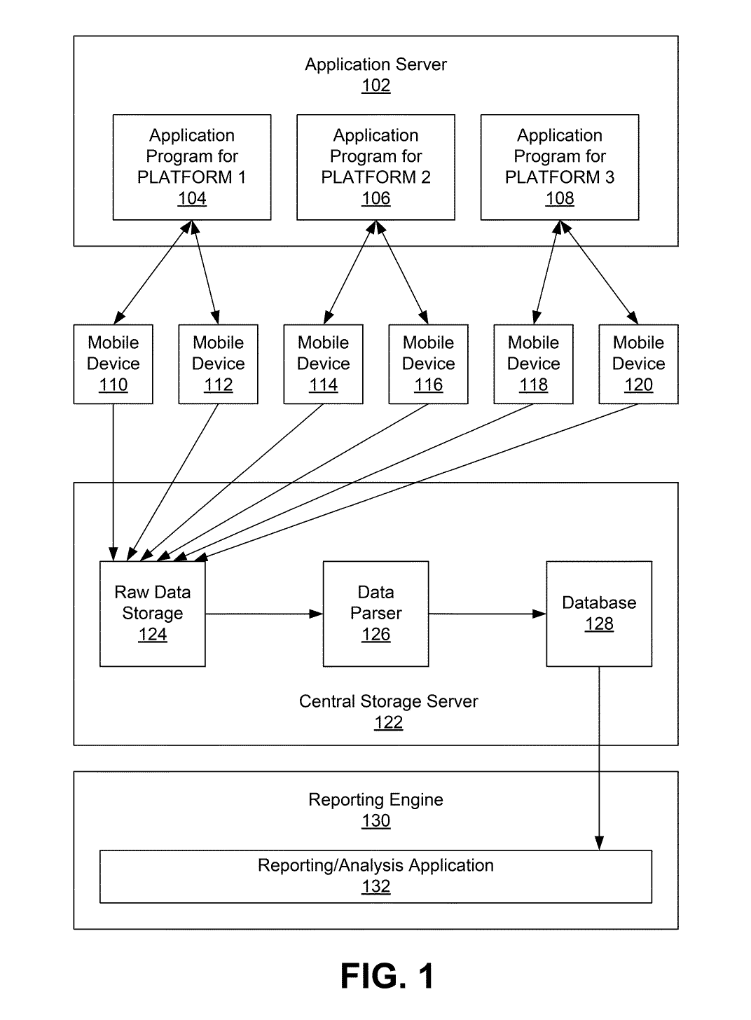

FIG. 1 illustrates an exemplary user-device interaction logging and reporting system. The user-device interaction logging and reporting system may include application programs for installation on mobile devices and for collecting usage data and related user feedback on the mobile devices. In order to conduct studies involving numerous possible questions which are desired to be answered, it may be desirable to gather as much relevant information from mobile devices as possible. Therefore, it may be desirable to be able to support the use of many different mobile device platforms in the studies. Consequently, the exemplary user-device interaction logging and reporting system may include a variety of versions of the application programs for installation on the various mobile device hardware and operating system platforms available.

An application server 102 may distribute the application programs for performing methods of the present invention to one or more mobile devices. The one or more mobile devices may comprise one or more different platforms. A platform may be considered a type of hardware device combined with a type of operating system software. For example, mobile hardware devices may include cellular telephones, smartphones, personal digital assistants (PDAs), and network computers (e.g., nettops or netbooks). Mobile operating system software may include software specifically designed to operate on the mobile hardware devices to provide the core functionality of the mobile hardware devices, e.g., control overall operations of the mobile hardware devices. The core functionality may also include providing cellular or text-based electronic communications. The mobile operating system software is generally provided pre-installed on the mobile hardware devices by the manufacturer. The mobile operating system software may support the additional installation and execution of application-specific software (e.g., apps) by users to perform additional functions beyond those provided by the host mobile operating system software. The application-specific software supported by the mobile operating system software may include the application programs for performing methods of the present invention.

The application programs may include an application program for Platform 1 104, an application program for Platform 2 106, and an application program for Platform 3 108. The mobile devices may include mobile devices 110 and 112 which include Platform 1, mobile devices 114 and 116 which include Platform 2, and mobile devices 118 and 120 which include Platform 3. In various embodiments, the application server 102 may comprise application programs for more or fewer platforms, and there may be more or fewer mobile devices which download and install application programs for each platform provided by the application server 102. The application server 102 may automatically determine the type of platform included on each mobile device 110, 112, 114, 116, 118, and 120 such that the appropriate one of the application programs 104, 106, and 108 may be downloaded and installed on the respective mobile device. The determination of the type of platform may include determining the manufacturer, model, and revision of the mobile device hardware as well as determining the version of the operating system software included on the mobile device. The determination may be made using a communications protocol between the application server 102 and the mobile device in which the mobile device communicates information regarding the mobile device's hardware and operating system software to the application server 102. The application server 102 may include a web server and/or a Wireless Application Protocol (WAP) Portal to provide the functionality of automatically determining the type of platform of the mobile device.

In some embodiments, a single application server 102 may be utilized for a variety of different studies, each of which may have a different application program 104, 106, and 108 configured for installation on the mobile devices 110, 112, 114, 116, 118, and 120. Depending on the specific study in which a user of the mobile device is invited to participate, the user may be sent a link to a different instance of the application program 104, 106, and 108 targeted to the specific study. The application program 104, 106, and 108 may be customized to only gather the information relevant to the specific study, and thereby minimize computational, energy, and bandwidth resources while enhancing the user experience. In some embodiments, the customization of the application program is achieved through customization of a configuration file which accompanies the application program, rather than the executable code of the application program itself.

In one embodiment of the present invention, the application server 102 transmits an invitation to download the application program to a mobile device via a message such as a Short Message Service (SMS) message. The invitation may include a link to a web site (e.g., landing page) that activates a download and/or installation of the application program to the mobile device when the user selects a download link or icon. A user of the mobile device may decide whether to download and install the application program in response to receiving the message from the application server 102.

Each of the application programs 104, 106, and 108 may include an installation module which is responsible for installing the application program on the mobile device after being downloaded to the mobile device. Each of the application programs 104, 106, and 108 may also include a main event gathering module which gathers and normalizes data pertaining to events monitored on the mobile device on which the application program is executing as described elsewhere herein. Each of the application programs 104, 106, and 108 may further include a watchdog which acts upon termination of the main event gathering module to re-start the main event gathering module.

The application program 104, 106, or 108 may function to collect and log data pertaining to a user's interaction with a mobile device such as the mobile device 110, 112, 114, 116, 118, and 120. The data may be collected by monitoring the user's interaction with the mobile device. The logged data may be transmitted by the mobile device 110, 112, 114, 116, 118, or 120 to a central storage server 122. The logged data may be processed for later analysis of the user's behavior with respect to the mobile device. The central storage server 122 may include a hard disk drive, electronic memory, or other computer-readable storage medium resident on a computer system such as a computing server. In various embodiments, the central storage server 122 may be included in the application server 102 or may be included in a separate and distinct computing server. Communications and data transmissions between the mobile devices 110, 112, 114, 116, 118, and 120 may be carried over a wireless communications network such as a cellular telephone network, WiFi network, WiMax network, EDGE network, GPRS network, EVDO network, or other wireless data communications system. In some embodiments, communications and data transmissions may be carried over a wireless data link such as a BLUETOOTH link or a wired network or data link, such as an ETHERNET network or USB data link.

The central storage server 122 may include raw data storage 124 which stores the data received from the mobile devices 110, 112, 114, 116, 118, and 120. The raw data storage 124 may include a unique identifier identifying the specific mobile device from which the respective stored data is received. The central storage server 122 may send an acknowledgement statement to the mobile device from which the data stored into the raw data storage 124 is received. If the mobile device does not receive the acknowledgement from the central storage server 122 after a period of time, the mobile device may transmit the data to the central storage server 122 again. The data may then be parsed by a data parser 126 and stored into a database 128 for later analysis and reporting. In some embodiments, the data from the raw data storage 124 may be normalized depending on the platform of the mobile device from which the data was obtained. The normalization may facilitate direct analysis and comparisons of data obtained from different platforms with each other by compensating for the differences between the different platforms.

In some embodiments, the central storage server 122 may include information about availability of new versions of the application program installed on the mobile device in the acknowledgement statement transmitted to the mobile device after receiving the logged data. The central storage server 122 may instruct the mobile device regarding when to connect with the central storage server 122 again by providing or updating communication timing parameters. In some embodiments, the central storage server 122 may include commands and configuration data for the application program to provide queries to the user of the mobile device according to the user's interaction with the device as monitored by the mobile device and/or as identified in the logged data received from the mobile device by the central storage server 122. In some embodiments, the commands and configuration data for the application program may cause queries to be provided to the user according to other factors associated with the mobile device, such as a time of day, geographic position of the mobile device, number of missed phone calls, number of voice mails, or battery status.

A reporting engine 130 may be used to analyze and generate reports based on the data in the database 128. The reporting engine 130 may include a computer or computing server on which a reporting/analysis application 132 executes. The reporting/analysis application 132 may be an executable program which provides reporting and analysis functionality for conducting studies involving logging and reporting of user-device interaction using the mobile devices 110, 112, 114, 116, 118, and 120. The reporting/analysis application 132 may be used to sort and export the data stored in the database 128.

In some embodiments, the reporting engine 130 may be included in the same computing server as the central storage server 122, and may be included in the application server 102. In these embodiments, a server application may include both a module which handles application program download requests from the mobile devices 110, 112, 114, 116, 118, and 120, as well as an administrative interface that includes the reporting/analysis application 132.

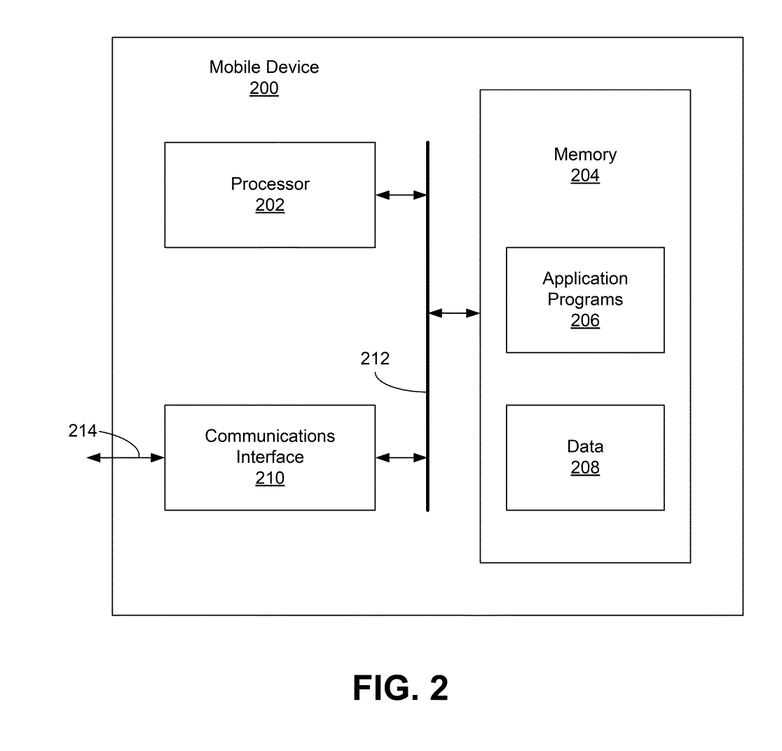

FIG. 2 illustrates an exemplary mobile device 200. The mobile device 200 may include embodiments of the mobile devices 110, 112, 114, 116, 118, and 120 of FIG. 1. The mobile device 200 may include a processor 202 which executes instructions of an application program to perform a method as described herein. The mobile device 200 may also include a memory 204. The memory 204 may store one or more application programs 206 which are executed by the processor 202. The memory 204 may also store data 208 which is generated by execution of the one or more application programs 206. The mobile device 200 may also include a communications interface 210 which communicates with external computing servers and/or mobile devices over a network or data connection 214. The network or data connection 214 over which the communications interface 210 transmits and receives data may include a wired or wireless network or data link. The communications interface 210, processor 202, and memory 204 may be communicatively coupled with one another over a data bus 212.

In various embodiments, the mobile device 200 may download an application program 206 over a wireless network using the communications interface 210, store the application program 206 in the memory 204, execute the application program 206 using the processor 202, and store data 208 pertaining to executing the application program 206 in the memory 204. The mobile device may also transmit the data 208 to a central storage 122 over a wireless network using the communications interface 210.

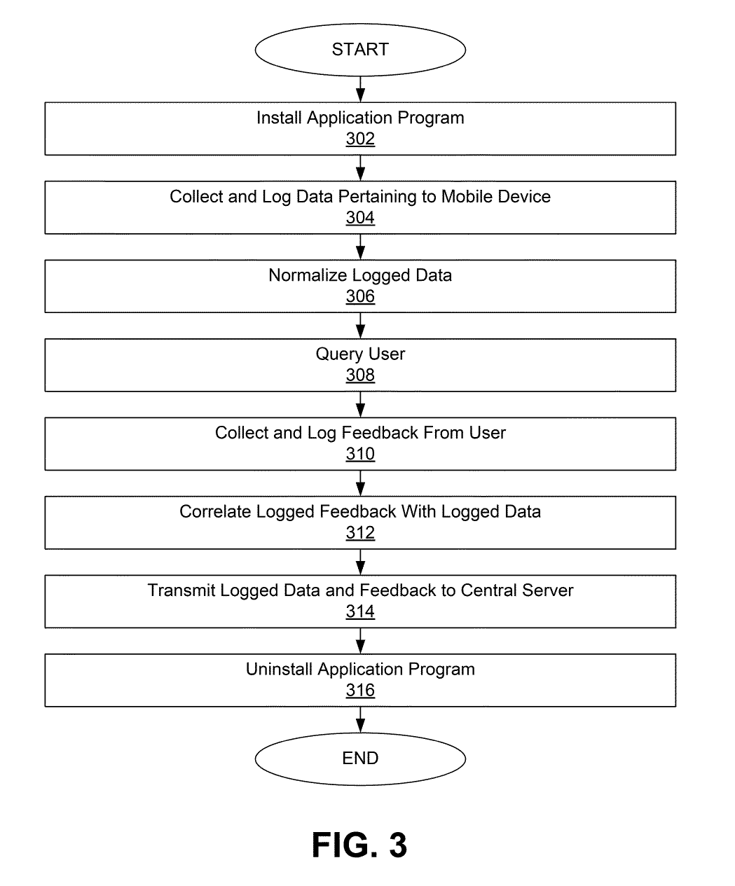

FIG. 3 illustrates an exemplary method of logging and reporting of user-device interaction. In various embodiments, additional steps not illustrated in FIG. 3 may also be performed, some of the steps illustrated may not be performed, and the steps may be performed in a different order than illustrated.

In a step 302, an application program for collecting usage data and related user feedback on a mobile device is installed on the mobile device. The application program may include instructions executable by a processor of the mobile device for performing steps of the method of logging and reporting of user-device interaction. The application program may also include or be accompanied by a configuration file that customizes the application program's functionality for a specific study with which the application program is being used. In some embodiments, the application program may be pre-installed on the mobile device before being provided to a user for conducting the study. In other embodiments, the application program may be made available at an application server for download to the mobile device. A notification (e.g., an SMS message or email message) may be sent to the mobile device regarding the availability of the application program for download and installation on the mobile device. A user of the mobile device may choose whether to download and install the application program. In some embodiments, the notification may include an invitation to the user to participate in a study involving user-device interaction, and the download and installation of the application program may be automatic upon acceptance of the invitation to participate in the study. The study may include usability testing of products, market research, audience measurement, or various other topics. The user may indicate acceptance of the invitation to participate in the study by selecting a download link contained in the notification to download and install the application program on the user's mobile device.

The application program may be automatically executed after installation, and upon start-up of the mobile device thereafter. The installation of the application program may include determining specific capabilities of the mobile device such that the application program may be tailored to function according to the specific capabilities provided by the mobile device on which the application program executes. The application program may function with any software resident and executing on the mobile device, including text-based as well as graphical web browser software. The application program may run in the background on the mobile device such that the user may not interact directly with the application program during the course of its operations. The application program may begin to monitor and log data regarding the user's interactions with the mobile device as well as the mobile device's network activities in the background after the application program is installed. This monitoring and logging process may be conducted continuously in order to trace changes in user's behavior over time and in response to the introduction of new devices, features, and software applications.

Once the application program is installed on the mobile device, the application program and the server may communicate regarding the availability of new versions of the application program and updates to configuration files associated with the study. This information may be included in an acknowledgement statement sent by the central server after retrieving logged data and/or feedback from the mobile device (as described herein with respect to step 314). If a new version or update is available, the application program installed on the mobile device may switch from the background into the foreground and prompt the user to download and install the new version on the mobile device. In some embodiments, the new version may be downloaded and installed automatically without notifying the user or requesting the user's specific approval. If the new version fails to properly download and install to the mobile device, or the user chooses not to obtain the new version, the old version may stay in place on the mobile device.

In a step 304, data pertaining to the mobile device is collected and logged. The application program may continually monitor and gather information regarding the user's interaction with the mobile device, and log data pertaining to the user's interaction with the mobile device. The application program may also monitor and gather other information related to the mobile device, such as time of day, geographic position of the mobile device, number of missed phone calls, number of voice mails, or battery status. The information may be representative of the user's behavior with respect to the mobile device, software applications executing on the mobile device, network resources such as email and web sites accessed over a network via the mobile device, and/or the user's physical environment. The logging of data may be triggered by a particular event or pre-defined user interaction with the mobile device. Table 1 below lists example measurements and events which may be logged.

TABLE 1
Exemplary Mobile Logging Functionality

| | | | |
|---|---|---|---|
| 1 | Phone switched | User switches on the | Event + Daytime |
| | on | device | |
| 2 | Phone switched | User switches off the | Event + Daytime |
| | off | device | |
| 3 | Phone IMEI (im | Record the IMEI | IMEI |
| | Header) | (unique identifier) of | |
| | | the mobile device | |
| 4 | Application | Record the name of | Name and Path of Application + Daytime |
| | started running | any application started | |
| | in foreground | on the mobile device | |
| | | by user | |
| 5 | Application | Record the name of a | Name and Path of service + Daytime |
| | started in | service, started in the | |
| | background | background | |
| 6 | Application | Record the termination | Name and Path of application or service + |
| | Terminated | of a previously started | Daytime |
| | | application or service | |
| 7 | Call initiated | Notice any call | Dialed number + Daytime + Number |
| | | initiated by user | typed in/Click to call/from address |
| | | | book/etc |
| 8 | Call received | Notice any call | MSISDN + Daytime + Reaction (answer, |
| | | received by mobile | ignore, call forwarding) |
| | | device | |
| 9 | Call terminated | Notice the termination | MSISDN + Daytime |
| | | of a call (inbound and | |
| | | outbound) | |
| 10 | Text/SMS sent | Notice the sending of | MSISDN + Daytime + Length |
| | | an SMS | |
| 11 | Text/SMS | Notice any SMS | Sender MSISDN + Daytime + Length |
| | received | received | |
| 12 | MMS sent | Notice the sending of | MSISDN + Daytime + Length |
| | | an MMS | |
| 13 | MMS received | Notice any MMS | Sender MSISDN + Daytime + Length |
| | | received | |
| 14 | Email sent | Notice any Email sent | Recipient(s) to, cc, bcc + Daytime + |
| | | out by user | Length + Name(s) and Length(s) of |
| | | | possible attachments |
| 15 | Email received | Notice any Email | Sender MSISDN + Daytime + Length + |
| | | received by device | Name(s) and Length(s) of possible |
| | | | attachments |
| 16 | Key press | Track any Keystroke | Key + Daytime |
| | | initiated by user | |
| 17 | GPS Position | Save GPS location | |
| 18 | Key lock | Notice the locking of | Event + Daytime |
| | | the Keypad | |
| 19 | App Installation | Notice the installation | Name of application + Daytime + Source |
| | | of a new application on | |
| | | the mobile device | |
| 20 | App Un- | Notice the un- | Name of application + Daytime |
| | installation | installation of any | |
| | | existing application | |
| 21 | Data Traffic | Track the number of | Time: Start of tracking + Daytime: End of |
| | WLAN | bytes transferred via | tracking + Packets sent + Packets |
| | | WLAN in an interval | received |
| 22 | Data Traffic | Track the number of | Time: Start of tracking + Daytime: End of |
| | Network | bytes transferred via | tracking + Packets sent GSM + Packets |
| | | WAN in an interval | received GSM + Packets sent GPRS + |
| | | | Packets received GPRS + Packets sent |
| | | | CDMA + Packets received CDMA + |
| | | | Packets sent UMTS + Packets received |
| | | | UMTS |
| 23 | Memory | Find out the memory | Total Memory + Free Memory + |
| | available on | usage on the device | Daytime |
| | device | | |
| 24 | Presence and | Notice removal and | Presence + Daytime |
| | remove/insert of | insertion of memory | |
| | memory cards | cards from or into the | |
| | | mobile device | |
| 25 | Idle Time (Idle | | Low |
| | screen on) | | |
| 26 | Power save | Notice when and how | Event + Daytime ++ . . . |
| | mode | often the device falls | |
| | | into power safe mode | |
| 27 | Startup from | Notice when and how | Event + Daytime ++ . . . |
| | power save | often the device returns | |
| | | from power save mode | |
| 28 | Network | Record the names of | (Provider Name + Daytime) + (. . .) |
| | provider name | the connected network | |
| | | providers over time | |
| 29 | Network signal | Record the signal level | (Level + Daytime) + (. . .) |
| | strength | over time | |
| 30 | Battery level | Record the battery | (Level + Daytime) + (. . .) |
| | | level over time | |
| 31 | Charging status | Record the charging | (Status + Daytime) + (. . .) |
| | | status over time | |
| 32 | Bluetooth status | Monitor and trace any | Bluetooth activities + Daytime |
| | | Bluetooth activity in an | |
| | | interval | |
| 33 | GSM Cell Info | Save GSM Cell | |
| | | Information | |
| 34 | Relative | | |
| | orientation of | | |
| | device | | |
| 35 | Ambient | | |
| | brightness | | |
| 36 | URLs visited by | Track the URLs visited | (URL + Daytime) + (. . .) |
| | browser | by the mobile device's | |
| | | browser | |
| 37 | Song starts or | Record the Names, | Name, Artist, Source, Length, Encoding, |
| | stops playing | Length, StartTime and | StartTime, EndTime |
| | | EndTime of a | |
| | | Soundfile started in the | |
| | | Built In SoundPlayer | |
| 38 | Video | Record the Names, | Name, Artist, Source, Length, Encoding, |
| | starts/stops | Length, StartTime and | Resolution, StarTime, EndTime |
| | playing | EndTime of a Video | |
| | | started in the Built In | |
| | | Video Player | |
| 39 | Picture is taken | Record the Events | Picture Dimensions, Size, Filename, |
| | and saved | initiated by the Built In | Daytime |
| | | Camera. | |
| 40 | Video is taken | Record the Events | Video Dimensions, Length, Size, |
| | and saved | initiated by the Built In | Filename, Encoding, Daytime |
| | | Camera | |
| 41 | Sound is | Record the Events | Length, Size, Filename, Encoding, |
| | recorded and | initiated by the Built-in | Daytime |
| | saved | Sound Recording | |
| | | functionality | |
| 42 | Contact added | Notice the Adding of a | Contact Information, Daytime |
| | | contact in the Personal | |
| | | Information Manager | |
| 43 | Contact modified | Notice a change in a | Contact Information (New), Daytime |
| | | contact in the Personal | |
| | | Information Manager | |
| 44 | Appointment | Notice the adding of an | Appointment Information + Daytime |
| | added | appointment in the | |
| | | calendar | |
| 45 | Appointment | Notice any change to | Appointment Information (New) + |
| | modified | an existing | Daytime |
| | | appointment in the | |
| | | calendar | |
| 46 | To-do added | Notice the adding of an | ToDo Information + Daytime |
| | | item to the ToDo List | |
| 47 | To-do modified | Notice any change to | ToDo Information (New) + Daytime |
| | | an existing item on the | |
| | | ToDo List | |
| 48 | New Ringtone | | |
| | installed | | |
| 49 | System Ringtone | | |
| | changed | | |
| 50 | Device opened | Record any open or | (open/close + Daytime) + (. . .) |
| | or closed | close event of the | |
| | | device over time | |
| 51 | CDMA Cell Info | Saves CDMA Cell | |
| | | Information | |
| 52 | iDEN Cell Info | Saves iDen Cell | |
| | | Information | |

Data may be logged by using an event interception process. An event interception process may use a call-back function or other platform-provided functionality for notifying the application program of a specific identified event. When the application program is so notified, the application program may collect the data relevant to the event and log the data. Alternatively, the application program may actively monitor specific system properties pertaining to the information desired to be logged, and deduce information regarding events from the monitored system properties. The application program may then log the deduced information. For example, the application program may monitor a list of active processes executing on the platform, and when a specific process which is being monitored becomes active, the application program may deduce that the user has begun execution of the newly active process and log data pertaining thereto.

Measurements and events which are logged may be dependent upon the specifications and capabilities of the respective mobile device on which the application program is executing. For example, an application program executing on a mobile device that includes a cell phone but no camera will not log data pertaining to a length of time that a video is recorded by the mobile device. The application program may only record and log data pertaining to events and measurements which are applicable to the specific mobile device on which the application program executes.

In addition, measurements and events which are logged may be dependent upon a configuration file provided to the mobile device in conjunction with the application program. The configuration file may define measurements and events which a researcher conducting the study is interested in collecting and logging. The configuration file may be text-based, and be readable and/or editable by the researcher using readily available software programs. The application program may only record and log data pertaining to events and measurements which are identified in the configuration file. The researcher and/or user of the mobile device may desire to limit the range of events and measurements which are collected and logged by the application program in order to minimize the application program's impact on the mobile device's performance, memory space, and/or battery life. A single configuration file may be utilized with any or all platforms supported by the application program, thereby simplifying the overhead associated with performing a study involving many different platforms, each of which may use a version of the application program specifically developed or configured for use on the platform. Alternatively, the researcher may define a number of different configuration files, and associate each of the different configuration files to a different set of users or mobile devices participating in the study.

The information gathered by the application program may be written into a log file in the memory of the mobile device. The log file may be a human readable text file, a binary file, an encrypted file, an image file, a video file, or any other format file capable of storing the logged data for later access and analysis. The log file may be in a format which is efficient for transmission over the network to the central storage server 122.

In a step 306, the data logged by the application program may be normalized to compensate for any differences between the mobile device platform on which the application program is executing and other mobile device platforms with which other users participating in the study may interact. These differences may include how events are raised on the different platforms and differences in information associated with logging data associated with the events on the different platforms. By normalizing the data gathered by the application program, analysis and reporting of the data in conjunction with data collected on other different platforms may be easier and more consistent. This normalization may be performed by the application program executing on the mobile device, or by software executing on a server, such as the central storage server 122 or a server hosting the reporting engine 130.

In a step 308, a user of the mobile device is queried. In some embodiments, the query may be triggered by a particular pre-defined user interaction with the mobile device. The user may be queried regarding the user's interaction with the mobile device to which the logged data of step 304 pertains. The query may be specifically tied to the logged data pertaining to the user-device interaction in step 304, for example by being triggered by, generated in response to, or formulated in accordance with the data logged in step 304. For example, the trigger for the user to be queried may include visiting a web site using a web browser. In some embodiments, the query may be triggered by an event of the mobile device such as time of day, geographic position of the mobile device, number of missed phone calls, number of voice mails, or battery status.

A questionnaire engine included with the application program may present the user with a simple questionnaire from time to time. For example, the questionnaire may query the user regarding the user's experience with some feature or software on the mobile device, some web site accessed using the mobile device, or what the user is doing at a particular time or place. In some embodiments, the questionnaire engine may be triggered and present the queries without further direct involvement of a server external to the mobile device, such that the queries may be presented and feedback collected even when there is no network access available to the mobile device and the mobile device is offline. In other embodiments, the query may include accessing a web site or server over a network.

In a step 310, feedback from the user in response to the query of step 308 is collected and logged. The feedback may be collecting via user interaction with the mobile device, for example via selection of options and entering of text using a keypad of the mobile device. The logged feedback may include an identification of the query with which the feedback is associated. The logged feedback may also include data pertaining to the device and/or user interaction with the device at about the time the user was presented with the query at step 308.

In a step 312, the logged feedback of step 310 may be correlated with the data logged in step 304. The logged feedback may include an identification or pointer to the data logged in step 304 to which the logged feedback relates. In addition, the data logged in step 304 may be updated to include an identification or pointer to the logged feedback which relates to the logged data. The correlation may be particularly useful when the query of step 308 is tied to the data logged in step 304. The correlation of the logged feedback with the logged data may facilitate analysis of the logged feedback and logged data in context such that dependencies between the two may be accounted for in the analysis.

In a step 314, the logged data and feedback may be transmitted to a central server. The transmission may be over a wireless network, a wired network, and/or a data connection between the mobile device and a personal computer. The central server may include the central storage server 122. The application program may locally buffer the logged data and feedback on the mobile device such that a plurality of data and feedback entries are logged, and periodically transmit the plurality of logged data and feedback entries to the central server based on a passage of time or based on a request from the central server. In other embodiments, the application program may transmit each entry of data and feedback upon being collected and logged.

The application program may encode the data in a network-efficient format suitable for transmission over a wireless data network. The logged data may be transmitted using any one of a variety of protocols, including HTTP, TCP/IP, email, SMS, and MMS. The application program may also determine whether the mobile device is roaming or in its home network, and may wait until the mobile device is in its home network prior to transmitting the data in order to save on roaming charges. The transmission of the data may be restricted to certain times, locations, or connections in order to minimize costs. For example, the data may be restricted to transmission over a no-cost local area network (LAN) such as a WiFi LAN controlled by the user or the operator of the central storage server 122. In other embodiments, the logged data and feedback may be manually copied to the raw data storage 124 rather than be automatically transmitted over a network.

In a step 316, the application program may be uninstalled from the mobile device. In some embodiments, the user of the mobile device may manually uninstall the application program from the mobile device. In other embodiments, the application program may be uninstalled in response to a command to do so received over the network, for example from the application server 102 or central storage server 122. The application program may be uninstalled after the study with which the application program was associated is completed. In some embodiments, the application program may be deactivated rather than be uninstalled such that the application program no longer monitors and logs user interactions with the mobile device nor queries the user of the mobile device. The deactivated application program may still communicate with a server in order to receive commands and updates.

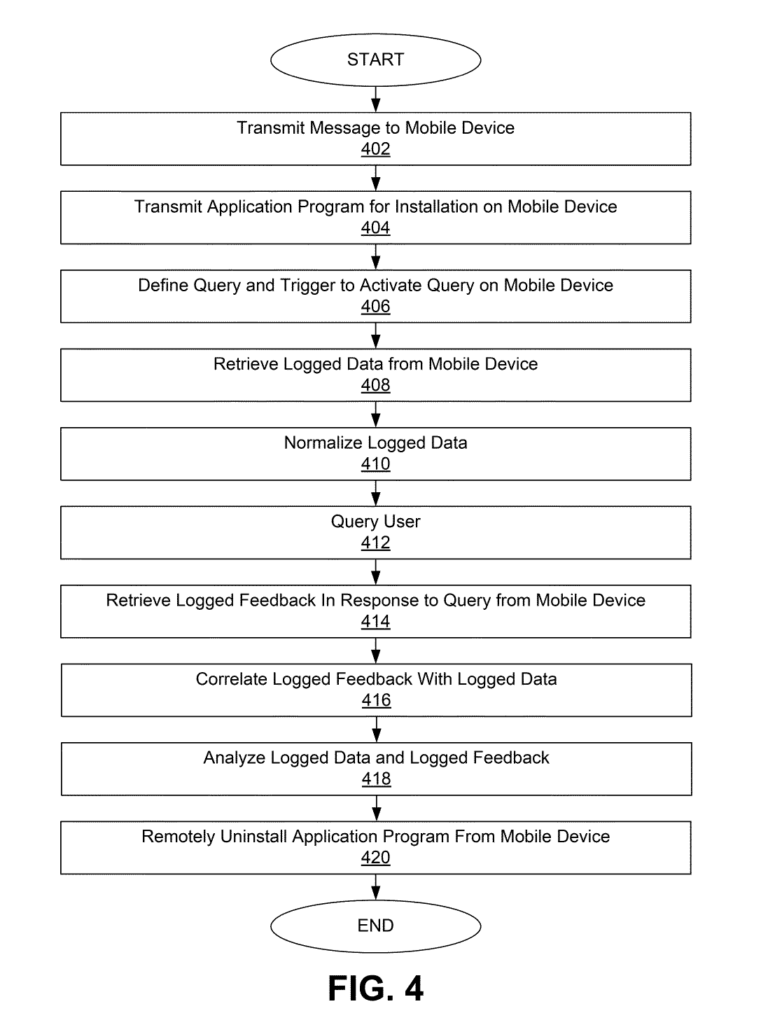

FIG. 4 illustrates an exemplary method of conducting a study involving user-device interaction using logged data from a mobile device. In various embodiments, additional steps not illustrated in FIG. 4 may also be performed, some of the steps illustrated may not be performed, and the steps may be performed in a different order than illustrated. Prior to performing the method, the study may be prepared by determining a list of potential participants, collecting contact information for the participants' own mobile devices (e.g., cellular telephone numbers, electronic serial numbers, MAC addresses, IP addresses, email addresses) or providing mobile devices to the participants, and configuring the hardware and software to be used in conducting the study.

In a step 402, a message may be transmitted to the mobile device from a central server to invite a user of the mobile device to participate in the study. The message may include a text message, an SMS message, an email, or other electronic communication. The message may include information about the study in which the user is invited to participate, and may include information on downloading and installing an application program for collecting usage data and related user feedback on the mobile device to facilitate the study. In some embodiments, the message may be sent to users already participating in the study to provide information about and download instructions for updates to the application program and/or configuration files associated with the study. The message may include a link to a server from which the application program may be downloaded for installation. The message may be repeatedly sent to the mobile device at periodic intervals until an acknowledgement is received that the user of the mobile device read the message and either explicitly accepted the invitation to participate in the study and install the application program, or explicitly declined the invitation.

In a step 404, the application program may be transmitted to the mobile device for installation. The application program may include instructions executable by a processor of the mobile device to perform steps of the method of conducting the study. The application program may be transmitted in response to at least the user's receipt of the message in step 402. The user may request that the application program be downloaded and installed from the server by selecting the link contained in the message of step 402 inviting the user to participate in the study, or by selecting an appropriate button on a web page (e.g., landing page) to which the link in the message of step 402 directs the user. The server may include a portal for providing the application program to the mobile device (e.g., a WAP portal or an HTML portal). The server may provide a different landing page for each of a number of different studies which the server supports. Each landing page may provide a differently configured application program (or different configuration files accompanying a common application program) to the mobile device for each of the different studies. In addition, the server may automatically determine the platform of the mobile device and deliver the appropriate application program for the corresponding device and operating system. The user experience of the installation process may be thereby enhanced, as the user does not need to know or enter the model and operating system version of the mobile device (e.g., cell phone) in order to download and install the application program.

When the user of the mobile device has accepted an invitation or the application program has been automatically commanded to update the application program or configuration files (for example in response to a notification included with an acknowledgement statement in steps 408 or 414), the central server may provide a landing page to the mobile device containing a link to the new version of the application program or configuration file according to the platform (e.g., hardware and operating system) of the mobile device and/or the study in which the user is participating. When the new application program or configuration file is installed on the mobile device, all existing logfiles may be deleted on the mobile device. Accordingly, the installation of the update may include uploading all logfiles on the mobile device to the server before the logfiles are deleted.

In a step 406, a query to present to the user of the mobile device and a trigger to activate the query on the mobile device may be defined. The query may be regarding the user's interaction with the mobile device. In other embodiments, the query may be related to what the user is doing at a particular time or place. The central server may be used to define selected events or types of events that are to be logged by the mobile device. The selected events or types of events that are to be logged as well as the associated queries may be stored in a configuration file maintained at the central server. Also, the central server may be used to define algorithms instructing the mobile device to watch for certain events and when the certain events occur, to take certain pre-determined action. For example, the application program on the mobile device may be configured by such an algorithm to detect when the user accesses a particular navigation feature on the mobile device, and when that user action is detected, the application program may be configured to inform the central server. The application program executing on the mobile device may be instructed to wait a certain period of time and then determine whether the user has stopped using the navigation feature, or has stopped moving. If so, the application program executing on the mobile device may inform the server which may then send a questionnaire to the user of the mobile device to rate the accuracy, directness, ease of use, etc. of the navigation feature. As a second example, the central server may not be involved in the real-time querying of the user. In this second example, the questionnaire engine of the application program on the mobile device may be configured using the configuration file as previously defined at the central server to perform the queries and log the data independently from the central server. The logged data may then be provided to the central server at a later time.

The definition of the query may include development of a questionnaire using the reporting/analysis application 132. The questionnaire may include multiple questions, each of which may be presented to the user of the mobile device in a separate screen. Each of the questions may be presented using one of a number of different question formats, as presented in Table 2 below. After one or more queries and/or triggers to activate the queries are defined, a configuration file including the definition may be stored and transmitted to the mobile device for use by the application program.

TABLE 2
Exemplary Questionnaire Formats

| Question Type | Description | Technique |
|---|---|---|
| Likert scale | One question plus 10-point | Set focus, then enter |
| | scale (0-9) | number via keypad or move |
| | | slider to define point on |
| | | scale |
| Semantic | One dimension, two end | Set focus, then enter |
| differential | points, plus 10-point scale | number via keypad or move |
| | (0-9) | slider to define point on |
| | | scale |
| Yes or no | One question and two | |
| | buttons: yes or no | |
| Text choices | One question and up to 4 | |
| | named text choices; user | |
| | can select only one, or one | |
| | or more | |
| Image choices | One question and up to 4 | |
| | small images; user can | |
| | select only one | |
| Open-ended | Textual: One question plus | e.g., 160 characters max |
| feedback | text input box | |
| Standard | e.g., System Usability Scale | |
| questionnaires | (SUS), or After-Scenario | |
| | Questionnaire (ASQ) | |
| Media to be | directly record audio file; | |
| attached to | directly take photo to | |
| questionnaire | attach; directly make a | |
| | video to attach | |
| Point position, | Record cursor or touch/tap | |
| touch gesture | coordinates, touch gesture | |
| or key entry | (e.g., flick or drag, along | |
| | with coordinates), key entry | |

A researcher developing a study with which the logging and reporting of the user-device interaction may be used may define the questionnaire using a software program for questionnaire construction, editing, and administration. The software program may be included with or integrated with the reporting/analysis application 132, or may be separate. The researcher may select and configure questionnaire modules and presentation options according to the questionnaire configuration options presented in Table 3 below. A different questionnaire may be developed for different users within the same study, or for different studies. Following definition of the questionnaire, the researcher may test the questionnaire, save the questionnaire as a configuration file, and determine a set of users of mobile devices to whom to provide the questionnaire using the server. The researcher may then schedule the questionnaire to be downloaded and/or presented to the users of the mobile devices participating in the study.

TABLE 3
Exemplary Questionnaire Configuration Options

| Option Type | Option Selections |
|---|---|
| Trigger | If any: the trigger and its value range |
| configuration: | If to be triggered: with which time delay |
| Scheduling: | from which overall start to which end date & time |
| | allowed presentation interval per day, e.g., from |
| | 6:30-23:00 |
| | repeatable/non-repeatable questionnaire |
| | if repeatable, how often questionnaire shall be |
| | presented to a person in total before data |
| | collection is complete |
| | if repeatable: maximum frequency in waking hours |
| | if repeatable: smallest permitted interval before next |
| | presentation (in minutes) |
| | if repeatable: interval of planned fluctuation/randomness |
| | of presentation |
| Exceptions | e.g., not while roaming |
| | e.g., not while making a call |
| | e.g., not if battery charge level below a predefined |
| | percentage |

In general, the questionnaires should optimize the user experience of the participants of the study to boost study participation and minimize errors in user input of feedback. To accomplish these goals, the questionnaires developed for mobile devices should conform to requirements and guidelines specific to mobile devices. Exemplary guidelines for queries are presented in Table 4 below. To enhance the perception of user friendliness, the questionnaire may also provide an optional, customizable, animated figure at a specified location in the user interface of the application program on the mobile device.

TABLE 4
Exemplary Query Guidelines for Mobile Devices

| Query Aspect | Guideline |
|---|---|
| Interaction design | To be operated one-handed: with 5-way navigation only |
| | (press numbers for quick access) |
| | Avoid screen scrolling |
| | One screen per question |
| | Allow for backward & forward navigation through multiple |
| | screens |
| | Minimize the number of keystrokes/selections required for |
| | each screen |
| | Provide status feedback during and after the questionnaire |
| | After questionnaire: provide closure, i.e. an action |
| | representing a save/end operation at the end |
| | During the questionnaire: show question x of y |
| | Should not lose user input, even if interrupted by phone call |
| | or the application crashes - pick up right where the participant |
| | stopped the last time |
| | Any touch feedback accelerators should be big enough to |
| | allow for selection with a fingertip |
| Provide a pleasant tone | Foreground/background contrast for each screen should be |
| & appearance | high, so that one can read it in adverse lighting situations |
| | (direct sunlight) |
| | Type should be big enough, and line weight should be high, |
| | so that one can read it easily while walking or commuting |
| | Be as polite as possible, i.e. say please & thank you |
| | Consider providing a whimsical touch, e.g., a small animated |
| | figure that greets the user and says goodbye, depending on |
| | cultural characteristics of study participants |
| Provide help | allow access to a test questionnaire that is typically always |
| | accessible |
| | contact details for study-related issues (e.g., Email address) |
| | contextual help, per each screen on the questionnaire |
| | concise privacy statement |
| Make the questionnaire | Should work with multiple screen sizes and orientations while |
| cross-device compatible | staying readable & usable, such as: 240 × 240, 320 × 320, |
| | 320 × 240, 240 × 320, 640 × 480, 480 × 640, and 800 × 480 |
| Input modalities | Assume only five-way navigation, no touch screen, no soft |
| | key (lowest common denominator for WINMOB) |
| | Soft keys & 12 key keyboard optional, only as accelerators |
| | Touch screen is optional, only as accelerator |
| | QWERTY is optional, only as accelerator |
| Should play nice with | Should not interrupt other real-time activities (e.g., while |
| regular usage of the | making a call, while navigating via GPS) |
| phone | Should work if interrupted by a phone call (and pick up again |
| | after the call has ended). |
| | Should be easy to “snooze” when it pops up automatically |
| | (“show again in x minutes”), e.g., if a call is expected |
| | Should not overburden the user with a multitude of |
| | questionnaires if the device was off for some time |
| | Should not be active during the night |
| Should be visually | Provide a customizable color palette, so that it can be |
| adaptable | customized for different clients and/or cultures. Palette to be |
| | switch-able per screen, to be customized by researcher |
| | Provide a bitmap background for the questionnaire, so that |
| | branding elements can be included |

In a step 408, logged data may be retrieved from the mobile device. In some embodiments, the logged data may pertain to the user's interaction with the mobile device. In other embodiments, the logged data may pertain to other factors associated with the mobile device, such as a time of day, geographic position of the mobile device, number of missed phone calls, number of voice mails, or battery status. The logged data may be retrieved via a connection over a wireless network, a wired network, or via a connection between the mobile device and a personal computer. The retrieval of the data may be instigated by the mobile device or by the server.

In a step 410, the logged data may be normalized such that differences between multiple different mobile device platforms may be accounted for when analyzing the logged data of a group of mobile devices of different platforms. The normalization may facilitate direct analysis and comparisons of data obtained from different platforms with each other by compensating for the differences between the different platforms.

In a step 412, the user of the mobile device may be queried. In some embodiments, the query may be triggered by a particular pre-defined user interaction with the mobile device. In other embodiments, the query may be triggered by an event of the mobile device such as time of day, geographic position of the mobile device, number of missed phone calls, number of voice mails, or battery status. The user may be queried regarding the user's interaction with the mobile device to which the logged data of step 408 pertains. In some embodiments, the user may be queried pertaining to any subject, and the user responding to the query may include user-device interaction. For example, the user may be queried periodically regarding what the user is doing at a given point in time. The user may be queried to take a photograph, record some audio, or record a video of something based on the user's location or based on a time of day. The query may be triggered by another user-device interaction, such as using a feature of a software application or accessing a particular page of a web site using a web browser on the mobile device.

In a step 414, the server may retrieve logged feedback in response to the query of step 412 from the mobile device. The logged feedback may be retrieved over a wireless network, a wired network, or via a connection between the mobile device and a personal computer. The retrieval of the feedback may be instigated by the mobile device or by the server.

In a step 416, the logged feedback retrieved in step 414 may be correlated with the logged data retrieved in step 408. The correlation of the logged feedback with the logged data may facilitate analysis of the logged feedback and logged data in context such that dependencies between the two may be accounted for in the analysis.

In a step 418, the logged data and the logged feedback may be analyzed, and an analysis result may be output. The analysis result may be output to a file, a printout, a computer screen, over a network to another computing device, or in another way as known in the art. The logged data and feedback may also be exported to various data files and reports. Prior to export, the data may be sorted and organized in various manners, such as by the mobile device from which the data originated, the time period during which the data was collected, etc. A software program, which may be included in the reporting/analysis application 132, may be used by a researcher to centrally query a database including the logged data and feedback in order to statistically determine a behavior of a user of a mobile device. For example, the software program may search the database to identify selected types of information or trends on selected mobile devices such as the time of day certain internet features are used, the length of calls versus the time of day the calls are made, most frequently texted area codes, the frequency of use of on-board phonebooks, etc. In response to the identified trends, new triggers and/or queries may be developed and transmitted to one or more mobile devices participating in the study to ask questions and collect data directed to obtaining useful data about the use of internet features, call lengths at different times of day, most frequently texted area codes, ease of use of phonebook, etc. in accordance with the identified trends.

In a step 420, the server may remotely uninstall the application program from the mobile device. The uninstallation may be performed at the conclusion of the study, when conducting the study is completed. Rather than completely uninstalling the application program, the server may simply remotely deactivate the application program so that it may be re-activated at a later time. When the application program is deactivated, it ceases monitoring and logging data on the mobile device. In some embodiments, the application program may continue to communicate with the server when deactivated in order to be updated to the latest version or receive new commands and configuration files from the server.

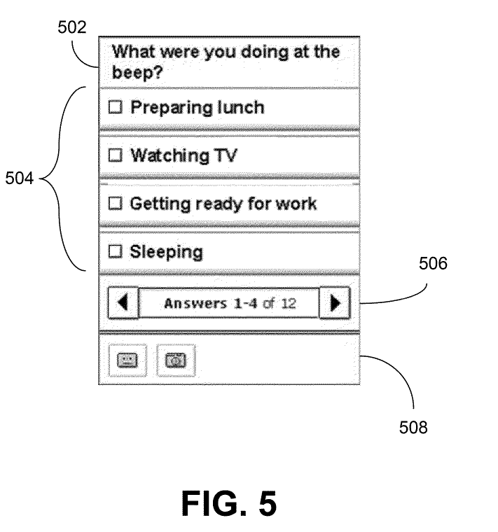

FIG. 5 illustrates an exemplary query displayed on a cell phone screen to sample the user's experience at a particular point in time. The query includes a question 502, followed by a number of potential responses 504 from which the user may select one. There may be more potential responses than may fit on a single screen, so the user may use the potential response navigation control 506 to move between two or more different response screens to find the potential response the user wishes to select. In queries with only a single response screen (e.g., the query may have five or four or fewer potential responses), the potential response navigation control 506 may not be displayed. After the user has selected a potential response, the user may press a response submission button in the response submission control 508 to send the response. The response submission control 508 may include an “OK” or “SUBMIT” button, as well as a “CANCEL” or “NOT NOW” button. The “OK” button may be configured to only be active after a user has selected one of the potential responses. If the user does not select a potential response for submission, the user may press the “CANCEL” or “NOT NOW” button in the response submission control 508 to close the window without submitting a response. The application program may either present the query to the user again in the future, or cancel the query altogether. Additional buttons and controls may be provided in the query as appropriate for the study and the nature of the specific query.

In general, the system or systems may be implemented using any general purpose computer or computers and the components may be implemented as dedicated applications or in client-server architectures, including a web-based architecture. Any of the computers may comprise a processor, a memory for storing program data and executing the program data, a permanent storage such as a disk drive, a communications port for handling communications with external devices, and user interface devices, including a display, keyboard, mouse, etc. When software modules are involved, these software modules may be stored as program instructions executable on the processor on a computer-readable storage medium, where the program instructions stored on this medium can be read by the computer, stored in the memory, and executed by the processor. Examples of the storage medium include magnetic storage media (e.g., floppy disks, hard disks, or magnetic tape), optical recording media (e.g., CD-ROMs or digital versatile disks (DVDs)), and electronic storage media (e.g., integrated circuits (IC's), ROM, RAM, EEPROM, or flash memory). The storage medium may also be distributed over network-coupled computer systems so that the program instructions are stored and executed in a distributed fashion.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

Preferred embodiments of the present invention are described herein, including the best mode known to the inventors for carrying out the invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

It will be recognized that the terms “comprising,” “including,” and “having,” as used herein, are specifically intended to be read as open-ended terms of art. The use of the terms “a” and “and” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

All references, including publications, patent applications, and patents, cited herein are hereby incorporated by references to the same extent as if each reference were individually and specifically indicated to be incorporated by reference and were set forth in its entirety herein.

What is claimed is:

1. A method of conducting a study involving user interactions with mobile devices, the method comprising:
installing a program executable by a processor for performing steps of the method on a mobile device;
collecting and logging data pertaining to the mobile device;
querying the user in response to a trigger event of the mobile device to which the logged data pertains; and
collecting and logging feedback from the user, via user interaction with the mobile device, in response to the query.

2. The method of claim 1, further comprising transmitting the logged data and user feedback to a central server.

3. The method of claim 2, wherein transmitting the logged data and user feedback is performed upon collection of an entry of the logged data and user feedback.

4. The method of claim 2, wherein transmitting the logged data and user feedback is performed after a plurality of entries of logged data and user feedback have been collected.

5. The method of claim 1, wherein the program is installed in response to the user's selection of a download link contained in an SMS message inviting the user to participate in the study.

6. The method of claim 1, wherein the logging of data is triggered by a particular pre-defined user interaction with the mobile device.

7. The method of claim 1, wherein querying the user is triggered by a particular pre-defined user interaction with the mobile device.

8. The method of claim 7, wherein the particular pre-defined user interaction comprises visiting a web site using a web browser.

9. The method of claim 1, further comprising uninstalling the program from the mobile device when the study is completed.

10. The method of claim 1, further comprising normalizing the logged data to compensate for differences between the mobile device to which the logged data pertains and other mobile devices with which other users participating in the study interact.

11. The method of claim 1, further comprising correlating the logged data pertaining to the mobile device and the logged feedback from the user in response to the query.

12. A method of conducting a study involving user interactions with mobile devices, the method comprising:
transmitting to a mobile device a program executable by a processor for performing steps of the method for installation on the mobile device;
retrieving logged data pertaining to the mobile device; and
retrieving logged feedback collected from the user in response to a query triggered by an event of the mobile device to which the logged data pertains, the feedback collected via user interaction with the mobile device.

13. The method of claim 12, wherein the retrieved logged data and user feedback is transmitted over a wireless network by the mobile device.

14. The method of claim 12, further comprising transmitting an SMS message to the mobile device inviting the user to participate in the study, and wherein transmitting the program is in response to user's selection of a download link contained in the SMS message.

15. The method of claim 12, further comprising remotely uninstalling the program from the mobile device when the study is completed.

16. The method of claim 12, further comprising normalizing the logged data to compensate for differences between the mobile device to which the logged data pertains and other mobile devices with which other users participating in the study interact.

17. The method of claim 12, further comprising correlating the logged data pertaining to the mobile device and the logged feedback collected from the user in response to the query.

18. The method of claim 12, further comprising querying the user.

19. The method of claim 12, further comprising analyzing the logged data and logged feedback and outputting an analysis result.

20. The method of claim 12, further comprising defining the query and a trigger to cause the query to be presented to the user.

21. A mobile device for conducting a study involving user interactions with mobile devices, the mobile device comprising:
a processor that executes instructions of a software program;
a communications interface that communicates with a central server over a network, the communications interface communicatively coupled with the processor; and
a memory communicatively coupled with the processor, the memory having stored thereon a program executable by the processor for performing a method of conducting a study involving user interactions with mobile devices, the method comprising:
collecting and logging data pertaining to the mobile device;
querying the user in response to a trigger event of the mobile device to which the logged data pertains; and
collecting and logging feedback from the user, via user interaction with the mobile device, in response to the query.

22. A computer-readable storage medium having stored thereon a program executable by a processor for performing a method of conducting a study involving user interactions with mobile devices, the method comprising:
transmitting to a mobile device a program executable by a processor for performing steps of the method for installation on the mobile device;
retrieving logged data pertaining to the mobile device; and
retrieving logged feedback collected from the user in response to a query triggered by an event of the mobile device to which the logged data pertains, the feedback collected via user interaction with the mobile device.
